(19) United States
(12) Patent Application Publication
(10) Pub. No.: US 2014/0011190 A1
(43) Pub. Date: Jan. 9, 2014

(54) METHOD FOR PERFORMING A RAPID TEST

(71) Applicants: Markku Parviainen, Syvanniemi (FI); Ilkka Mononen, Turku (FI); Eira Kelo, Vuorela (FI); Fabrizio Galbiati, Kuopio (FI)

(72) Inventors: Markku Parviainen, Syvanniemi (FI); Ilkka Mononen, Turku (FI); Eira Kelo, Vuorela (FI); Fabrizio Galbiati, Kuopio (FI)

(73) Assignee: Oy Reagena Ltd, Toivala (FI)

(21) Appl. No.: 14/006,918

(22) PCT Filed: Mar. 23, 2012
(86) PCT No.: PCT/FI2012/050299

§ 371 Date: Sep. 23, 2013

(30) Foreign Application Priority Data
Mar. 24, 2011 (FI) 20115285

(51) Int. Cl. G01N 21/78

(52) U.S. Cl. CPC G01N 21/78
USPC 435/5; 436/501; 435/7.1

(57) ABSTRACT

The present invention relates to a method for performing a quantitative or qualitative analysis by a two-phase rapid test. In the method a signal reagent is placed into a container made of non-absorbing material, the container being located separate from the rapid test device. The signal reagent is reacted with the analyte(s) present in a test sample by adding the liquid test sample into the container. A reaction solution is obtained, which is then contacted with the rapid test device, wherein a detectable signal is developed. Subsequently, the development of the signal is monitored and read continuously.

### FIELD OF THE INVENTION

The present invention relates to a method for performing a quantitative or a qualitative analysis by a rapid test.

### BACKGROUND OF THE INVENTION

Various rapid tests are on the market, usually for qualitative purposes such as to test for pregnancy or time of ovulation, as described, e.g. in EP 0291194. The popularity of rapid tests is based on the fact that they are easy-to-use, fast and inexpensive. They are especially suitable for use at home, clinic or doctor's office since they require minimum degree of skills or training from their users. The possibility of user errors can be kept in reasonable control by using special sample collection devices first contacted with the sample, and then put into contact with the rapid test.

Rapid tests are based on the principles presented, for example in EP 0299428, WO 92/01226 and U.S. Pat. No. 5,712,170. The devices disclosed in these publications are based on membrane material which contains all the reagents needed for analyzing a sample in such a way that the signal reagent required for the test is placed on a test strip so that the sample placed on the strip moves in the strip system and dissolves the signal reagent by means of liquid flow. Subsequently, the sample and the signal reagent move ahead in the strip system by means of capillary forces. Molecules attached to the membrane structure bind the signal reagent, thus forming a coloured image on the membrane.

Still, the rapid tests as described have quite high analytical variation, and their sensitivity and accuracy has been questioned, especially in the field of infectious diseases (see e.g. Journal of Clinical Microbiology, 2002, vol. 40, p. 736-737; Acta Tropica, 2002, vol 82, p. 51-59; Emerg Infect Dis [serial on the Internet], 2009 Available from http://www.cdc.gov/EID/content/15/10/1662.htm).

The tests as described above are conventional one-phase rapid tests. Placing the signal reagent directly into the test structure is useful in applications, in which the rapid test needs to be especially user-friendly and easy to manufacture. On the other hand, the signal reagent placed in the test structure causes significant measuring inaccuracy due to the non-simultaneous detachment and dissolution of the signal reagent. This phenomenon is generally seen especially in those rapid tests that use blood or blood derivatives as samples. For instance, differentiation of positive and negative results can be difficult by naked eye. One possible solution to this problem is disclosed in EP1416275, which describes a control device for a rapid test.

In order to make the rapid test interpretation objective instead of visual inspection by naked eye, optical reading instruments that are able to convert the intensity of the line formed into a numerical value are used. By comparing the intensity of the line formed to the standard value entered to the device in advance, the device can then conclude the quantity of the substance under measurement in the sample. This technique enables in part quantitative measurements with rapid tests, but it cannot take into account the changes in the preparation and making of the tests, which directly cause inaccuracy to the result.

U.S. Pat. No. 6,258,548 discloses a lateral flow device and a method for performing semi-quantitative visual or instrument-based detection in a sample of a large molecular weight analyte containing two binding domains (a sandwich format) as depicted by an example of human chorionic gonadotrophin (hCG). The conjugate zone of the lateral flow device contains two reagents. The first reagent is a contrast reagent and the second one is an indicator reagent. The analyte concentration in the test sample is evaluated by comparing the ratio of the contrast and indicator signals in the analyte test zone with signal ratios for known analyte concentrations.

The optical readers currently in use can be based on photodiode or CD camera techniques, measuring of reflected light or of fluorescence. In the current techniques, reading of the result may be carried out by forming a ratio by means of the test line formed in the test strip and a control line, and by calculating the result by means of a value entered in advance. However, this technique is also incapable of taking into account the variation among sets or lots of tests, in which case the result of the analysis can be inaccurate or false.

US Patent application No. 2008/0070234 discloses a method for quantitative determination of an analyte in a sample by measuring the signals formed in immunological test strips at different time points, and reading the results from the respective calibration curve representing the time point (6, 8 and 12 minutes). As a result, a measuring range extension of chromatographic rapid tests is achieved.

EP 1369473 discloses an automated cassette module for an apparatus for conducting immunoassays, and use thereof. The cassette module contains an immunoassay cassette for detection of an analyte in a liquid body-fluid sample, a sample well, a mounted support to enable sample transfer, and a reagent reservoir and a reagent strip carried on the body and support. The reagent reservoir is a porous carrier containing the first reagent. The second reagent is contained in the reagent strip. The cassette handling instrument includes operations for use of the cassette, as well as a photo-detector to detect changes on the reflectance of the detection zone. The signal ratio of end-point reflectance to initial reflectance is determined, and used to calculate analyte concentration from a standard curve obtained with samples with known amounts of the analyte.

US Patent application publication 2005/0059160 describes a method for quantifying a rapid immunochromatographic test. The method comprises acquiring a digital image of the test with an image acquiring unit, acquiring at least one main characteristics of the digital image with a characteristics acquiring unit, calculating and quantifying the main characteristics of the digital image with a neural-network quantifying unit, and sending the results of the quantification to an output unit.

PCT application WO 2009/063185 describes another method and apparatus for reading, recording and optionally transmitting results from rapid point-of-care tests and drug tests. The apparatus described is shown to be advantageous in forensic application. The invention discloses a method for portable apparatus for reading and processing results from rapid test devices for various applications consisting of PDA with colour camera, operating system and analysis system and analysis algorithm, reader housing, carrying case and electrical charger(s).

PCT application WO 2009/014787 describes a system and method for detecting multiple analytes from a sample. In said method a sample is taken into a sample collection device, which contains a pair of probes and an extraction reagent. The analyte-probe complex is then administered to a test device, wherein the detection reaction takes place, i.e. a detectable signal is provided, which can subsequently be read to determine which analytes are present in the sample processed. The results are read using end-point analysis, in 5 to 60 minutes, or even from several hours to a few days. The applicant states that the fact that the signals produced are stable for long periods, is a great improvement to point-of-care diagnostics.

### SUMMARY OF THE INVENTION

The object of the present invention is to provide an improved method for performing a rapid test. In the method a signal reagent is placed into a container, into which a liquid sample is added. The reaction solution obtained is put into contact with a rapid test strip, and a signal so developed is continuously monitored by a reading apparatus, which enables kinetic measurement. The result is obtained in 1-3 minutes. The object of the invention is achieved with the method, the characteristics of which are disclosed in the appended claims.

### BRIEF DESCRIPTION OF DRAWINGS

FIG. 1 shows the layers of the rapid test strip used in the present invention. 100=rapid test strip (=101+102+103+107), 101=analysis membrane, 102=support, 103=absorbent membrane, 107=sample membrane.

FIGS. 2a to 2c show the detection cartridge 116 used in the present invention, the rapid test strip 100 being enclosed in the cartridge. FIG. 2a shows a rapid test for qualitative applications (115=upper part of the cartridge, 117=sample well), FIG. 2b shows a rapid test for quantitative applications (115=upper part of the cartridge, 118=sample port, 119=buffer well) and FIG. 2c shows a rapid test for qualitative applications, the upper and the lower parts of the cartridge shown separately (100=rapid test strip, 114=lower part of the cartridge, 115=upper part of the cartridge).

FIG. 3 presents a schematic view of the container 111 for the signal reagent. In this embodiment the container is a test tube (110=signal reagent).

FIG. 4 shows a schematic view of an apparatus for kinetic reading of the signal. (116=detection cartridge; 120=holder; 121=optical unit; 122=touch screen; 123=processor unit; 124=main power switch; 125=miniUSB connector; 126=chargeable battery; 127=Bluetooth Wlan unit.

FIG. 5a shows the detection curves obtained by performing quantitative CRP measurement with different CRP concentrations.

FIG. 5b shows the light reflectance reader values (y) of corresponding CRP concentrations (x) (end-point measurement).

FIG. 6 shows the results of the detection of group A Streptococcus antigen.

FIG. 7 Comparison of the results obtained by the rapid test of the present invention and by culturing group A Streptococcus (GAS). The light reflectance reader values (mean±SEM) as measured, and corresponding culturing results (negative, +, ++, +++) are shown.

FIG. 8 shows the curves obtained by performing Puumala virus IgM antibody detection.

### DETAILED DESCRIPTION OF THE INVENTION

The method of the present invention is a two-phase rapid test method, in which the first reaction (sample+conjugate) is carried out separately from the lateral flow strip of the detection cassette. Thereby, higher sensitivity is achieved than in conventional one-phase rapid tests, wherein the sample is applied directly into the test cassette. In the conventional test the conjugate is dissolved by the sample when it is flowing through the conjugate membrane, but part of the sample may not react with the conjugate. The conjugate is not dissolved steadily, which decreases the sensitivity. It should also be noted that in the present method a minor amount of the sample is sufficient, whereas in a conventional one-phase rapid test high amounts of sample are needed.

In the present method the amount of the conjugate is highly repeatable from one test to another, since a predetermined amount of the conjugate is applied to the tube or other receptacle separate from the rapid test device. A conventional rapid test includes a conjugate membrane, in which the amount of the conjugate is not repeatable due to, for instance, the porosity of the membrane.

The second reaction (detection reaction) of the present two-phase rapid test takes steadily place in the test line of the test strip, since the conjugate and the sample already have reacted with each other in the conjugate tube or other receptacle. The detection reaction may be continuously monitored from the very beginning, using an apparatus which enables kinetic measurement. The detection result is achieved faster, more accurately and more repeatably than previously, within 1 to 3 minutes. The coefficient of variation (CV) of the present method is lower than that of prior art methods. In traditional rapid tests the intensity of the test line is not developing steadily, due to the porosity of the conjugate membrane and uneven dissolution of the conjugate. The background of the test membrane may also be striped. The intensity is dependent on relatively high analyte concentration. Not even a very accurate analyzer gives the results rapidly, and the detection results are not repeatable (high CV).

The method of the invention allows real-time monitoring of the reaction in the test line, and the reaction rate is comparable to the concentration of the analyte to be detected. In conventional methods it is often necessary to wait until the end-point of the reaction, after which the detection may take place. The detection is carried out after 5 minutes, or later. The method of the present invention may be accurately standardized, whereby more accurate detection results are obtained than with prior art methods. With the method of the invention the end result may be rapidly anticipated accurately enough. The present method is suitable for a great amount of different analytes. There may be one or more analytes to be detected, i.e. the test membrane/strip includes several test lines in row, one line for each analyte to be detected. There may also be parallel test membranes/strips run simultaneously as in multi panel analyte screening.

The kinetic measurement exploited in the present method has earlier been used merely in chemical analyzers (see, e.g. Tietz Textbook of Clinical Chemistry and Molecular Diagnostics (eds. C. Burtis, E. Ashwood, D. Bruns), 5^{th} Ed. 2012 Saunders ISBN: 9781416-061649 (2256 pages)), in which the reaction takes place in liquid phase, in a cuvette, for instance. Such devices are laboratory equipment, the kinetic applications of which are being used for general enzymes. In such methods only one analyte at a time in the cuvette can be measured.

Consequently, in the method of the invention a predetermined amount of a signal reagent, which is the first assay reagent in the system, is placed into a container, into which a liquid sample containing one or several analytes is then added. The analyte(s) react with the signal reagent, and the reaction solution obtained is put into contact with a rapid test device, in which the solution flows ahead, and the signal reagent forms a signal in the detection zone. The rapid test device is preferably a lateral flow test detection cassette or strip. The signal formed may be visible or non-visible to human eye, depending on the materials used in preparation of the signal reagent. The signal formed is continuously monitored and detected by a reading apparatus, which enables kinetic measurement. This increases the reliability of the results obtained from the rapid tests, and enables more accurate quantitative measurement, and an easier and faster qualitative measurement than before.

The signal reagent container is located separate from the rapid test device, and it is made of non-absorbing material. Consequently, it does not absorb the signal reagent; neither forms it a reactive support for the reagent. The container may be any kind of sample or reagent receptacle, or alike; preferably it is a test tube. Suitable non-absorbing materials for preparing the container are, for instance, polypropylene, polyethylene and polystyrene. Also modifications of these materials are applicable.

The signal reagent used in this invention may, alternatively, be called as a particle reagent, since it is preferably prepared of small particles which are made, e.g., of heavy metal, such as gold, silver or platinum. Alternatively, the particle material may be carbon or plastic. The signal reagent contains bioactive molecules bound to the particles. The signal reagent is thus a conjugate, in which the bioactive molecules conjugated with the particles are, for instance, proteins, such as antibodies, polypeptides, polysaccharides or haptens, or any kind of antigens. Also mixtures of these are applicable. In a preferred embodiment of the invention, the bioactive molecule is an antibody.

The particles of the signal reagent may be 10 nm-1000 nm in size. By means of reagents having small particle size higher analytical sensitivity is achieved.

In the method of the invention, the signal reagent can be prepared with any method which produces particles labelled (conjugated) with proteins or other molecules.

According to the invention, suspension of the particulate signal reagent (particle suspension) may be put into a container which is located separate from the rapid test, and let the suspension dry. The container is then closed until further use. Alternatively, the signal reagent in dry form, as a pellet, for instance, may be placed into such a container. When the signal reagent is in dry form it remains viable even for several years. Therefore, by the method of the invention, longer viability for the signal reagent can be achieved than before.

In the method of the invention the reaction between the analyte molecules and the signal reagent takes place in the container, and the signal reagent is made to react with the sample analyte in a constant amount and concentration, which enables more accurate and more precise analysis of the analyte(s) under measurement in the sample than before. In the method, the signal reagent flows into the reaction zone of the rapid test device simultaneously with the analyte(s) under measurement.

In the method of the invention the rapid test device is a detection device or test strip which has one or several analyte-specific reaction zones, which contain one or several further assay reagents. The signal reagent as the first assay reagent, having been reacted with the analyte(s) contained in the sample, reacts with the second assay reagent in the respective reaction zone. The reaction with the second assay reagent takes place immediately after the signal reagent flow has reached the respective reaction zone. The second reaction will result in accumulation of the reaction product. The development of the signal is continuously monitored in the detection zone by real-time reading of the signal using apparatus which enables kinetic measurement. Consequently, the reaction is monitored as long as one can be sure that the result is positive or, alternatively, that the result is sufficiently reliable. It does not take more than 1 to 3 minutes.

In the method of the invention the concentration or amount of the reaction product formed with the second assay reagent is directly or indirectly proportional to the concentration or amount of the analyte(s) contained in the sample.

According to the invention, the dry signal reagent is dissolved in a few seconds into liquid form, as soon as the liquid sample has been added into the container. Alternatively, one or several other liquids, e.g. a dilution buffer, may be used to dissolve the dry signal reagent. The first assay reaction thus takes place in the container immediately after dissolution of the signal reagent. After adding the liquid sample the reaction solution, wherein the signal reagent is dissolved in the sample, is transferred with a device meant for transferring liquids into the rapid test device. Alternatively, the solution is absorbed directly from said container into the rapid test device, e.g. by simply dipping the rapid test strip into the solution. In the test strip, molecules bound to the reaction zone react with the signal reagent, and a detectable signal, e.g. a coloured line is developed in the test strip. The method in accordance with the invention is especially beneficial in cases where the intensity of the colour of the signal is meant to be either directly or indirectly proportional to the amount of the analyte(s) present in the sample.

In another embodiment of the invention the signal reagent may develop in the rapid test strip a non-visible, such as a fluorescence signal.

The analytes contained in the sample, i.e. the substances under measurement, may be nucleic acids, lipids, carbohydrates, vitamins, proteins, polypeptides, bacteria or viruses, or parts or mixtures of them. Preferably, the analytes are antibodies, antigens, metabolic products or metabolic markers. Typical examples of suitable analytes for quantitative assays are clinically important marker proteins, such as CRP, and for qualitative or semi-quantitative assays pathogenic bacterial strains, such as Group A Streptococcus, which is a significant cause of tonsillitis and pharyngitis, and other related infections. A further example is Puumala virus. Puumala virus IgM antibodies may be detected by the method of the present invention.

In the present invention the rapid test strip is preferably enclosed in a cassette, frame, cartridge or other similar structure. As a result, the usability of the test strip is improved, since the frame forms a solid structure, which is durable and easy to handle, around the rapid test strip. The structure can hold one or several parallel strips.

The rapid test strip enclosed in a cassette, frame, cartridge or other structure is placed into a holder of a specific reading apparatus. This holder is advantageously easily replaceable to hold different shapes of such structures. There are at least two alternative ways to perform the precise and accurate qualitative or quantitative analysis in accordance with the invention, the kinetic approach being preferable.
a) Utilizing the ‘end-point’ or ‘near-to-end-point’ immunoassay. Generally, in this embodiment, quantitative assays usually reach their end point in 5 to 10 minutes, and the measurement is carried out at a fixed time. Quantification is typically based on linear equation (i.e. the reader value is directly proportional to the concentration of the analyte under measurement in the sample) obtained by testing appropriate reference materials. In qualitative assays where the reaction does not stop, the measurement is generally carried out in 10 to 15 minutes at a fixed time. Again, the judgement of negative or positive, or semi-quantitative estimation can be based on preset cut-off values, or comparing with appropriate reference materials. In this embodiment, the test can be advantageously processed outside the reader for the preferred fixed time, followed by reading which usually takes only a few seconds.
b) Utilizing the preferable kinetic approach of the immunoassay. Typically, after starting the second reaction on the cartridge, the rapid test cartridge is placed into a specific reader apparatus, wherein the development of the signal in the reaction zone is monitored, and read continuously (near real-time). In this preferred embodiment the quantitative immunoassay reactions usually reach their highest reaction rate in about 1 minute, after which the reaction rate decreases. In qualitative assays, in which the reaction does not stop, the reaction rate is typically constant, and the measurement can be conducted in a few minutes. The reaction rate is concentration-dependent, and therefore the quantification or semiquantification or qualitative assay can be based on utilisation of this fact. In this embodiment, the test can be advantageously processed inside the reader for the preferred reaction time of approximately 1 to 3 minutes, followed by discharging the used cartridge before the use of next one.

The method of the present invention can thus be used for analysis and measurement of any substances that will bind to antibodies or antigens, but the substances under measurement, i.e. the analytes, may also be nucleic acids, lipids, carbohydrates, vitamins, proteins, polypeptides, polysaccharides, virus particles, or bacteria, or mixtures thereof. In specific, the analytes are antibodies, antigens, metabolic products or metabolic markers, or mixtures thereof.

For instance, CRP is a very important clinical marker of measuring infection from blood samples. CRP can be measured by several known methods such as turbidometric, EIA or fluorometric methods. What is common to these methods is that they are very equipment-bound; they require long preparation process and high expertise to do it. CRP is a protein molecule, the measurement of which always requires antibodies that bind to it, which antibodies may be polyclonal or monoclonal. The method in accordance with the present invention, and the device used, enable the measurement of CRP from a blood sample in an easy and fast way. In an advantageous embodiment of the invention the amount of CRP can be measured accurately using dedicated reading equipment based on a miniaturised camera reader. Alternatively, the dedicated reading equipment can be based on light reflectance reading principle.

The method of the invention may also be used in a semi-quantitative or qualitative detection of pathogenic bacteria, e.g. Streptococcus pyogenes (Strep A; Group A Streptococcus, GAS). The detection may be carried out from throat swab samples, or by identification of beta-haemolytic colonies from a culture. GAS is the most significant cause of tonsillitis and pharyngitis, and other related infections. The method detects streptococcal Lancefield group A antigen. The test result is read by a reader, which gives numerical values respective to the antigen amount in the sample.

The method in accordance with the present invention enables the measurement of Strep A more reliably than before. Since the result is based on numerical value, human-borne errors that usually hamper eye-read rapid tests are minimized. This increases diagnostic value of Strep A test compared to other tests available. Strep A method according to the invention helps in early diagnosis and immediate intervention of the GAS infection.

Puumala hantavirus infection, spread by bank vole (Clethrionomys glareolus), causes epidemic nephropathy (NE) in humans. A human being may be infected by the virus by secretions of the bank vole via breathing or touching. Epidemic nephropathy is not fatal to healthy people, but it may require extended hospitalization. Mortality to NE is 0.1-0.3% of infected patients. Some other diseases have symptoms similar to those of epidemic nephropathy, and therefore specific diagnostics of the disease is important in order to immediately start correct treatment. 99% of people with Puumala virus infection raise IgM antibodies, which can be detected from blood samples by immunological methods immediately after primary symptoms.

The method of the present invention enables a reliable measurement of Puumala virus IgM antibodies by over 95% sensitivity and specificity. Puumala IgM method according to the invention helps in early diagnosis and immediate intervention of Puumala virus infections.

The method according to the invention is explained below in more detail with reference to the accompanying Drawings. The examples given below describe the method of the invention and its use in measuring a clinically important marker protein CRP, and in detecting Streptococcus pyogenes (GAS), as well as Puumala virus IgM.

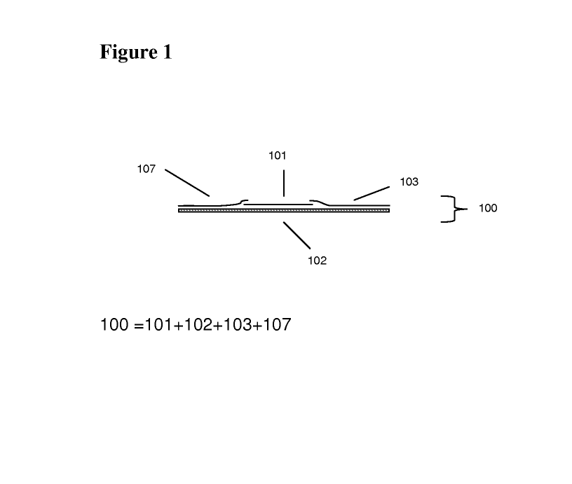

The rapid test strip 100 presented in FIG. 1 includes an analysis membrane (or test membrane) 101, a sample membrane 107, an absorbent membrane 103 and, in a preferred embodiment, a support 102. The analysis membrane 101 can be made of any material that allows the liquid flow and binds antibodies or antigens, but in an advantageous embodiment of the invention the analysis membrane is made of cellulose, nitrocellulose, polyvinyl fluoride, nylon, or polystyrene having porosity greater than 5 nm.

The sample and absorbent membranes 107, 103 of the rapid test strip are, in turn, preferably made of cellulose, glass fibre, polystyrene, nitrocellulose or nylon, or mixtures of these, or of any other material that absorbs liquids. The support 102 of the rapid test strip is made of any suitable material, on which the analysis, absorbent and sample membranes 101, 103, 107 are attached. Advantageously, the support 102 is made of polystyrene or polyvinyl derivatives, and it contains an adhesive for attaching the membranes.

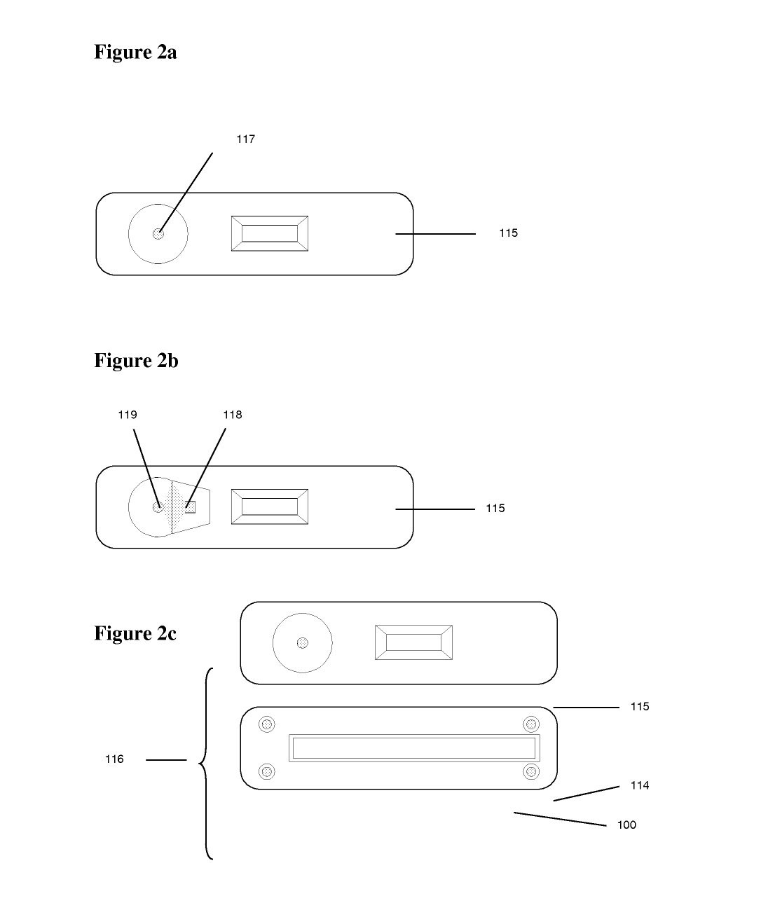

FIG. 2 shows a detection cartridge 116, which is a preferable form of the test device used in the present invention. The detection cartridge 116 consists of a lower and an upper part of the cartridge (114 and 115, respectively), which are adapted to be joined so that a rapid test strip 100 can be enclosed between the two parts.

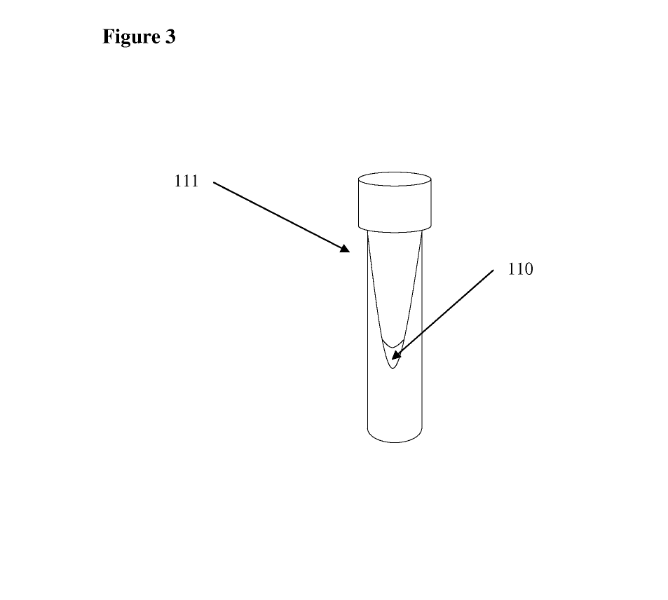

In FIG. 3 a test tube (container) 111 is illustrated, into which the signal reagent 110 has been placed. When carrying out the method of the invention, the sample containing the analyte is added into a separate container 111, which contains the dry signal reagent 110. In qualitative or semi-quantitative assays the reaction solution obtained, wherein the sample has solubilised the signal reagent, is then transferred into the sample well 117 of the detection cartridge 116, and the rapid test is allowed to run through. In quantitative assays the reaction solution obtained is transferred into the sample port 118 of the detection cartridge 116, followed by adding of the running buffer to buffer well 119, after which the rapid test is allowed to run through.

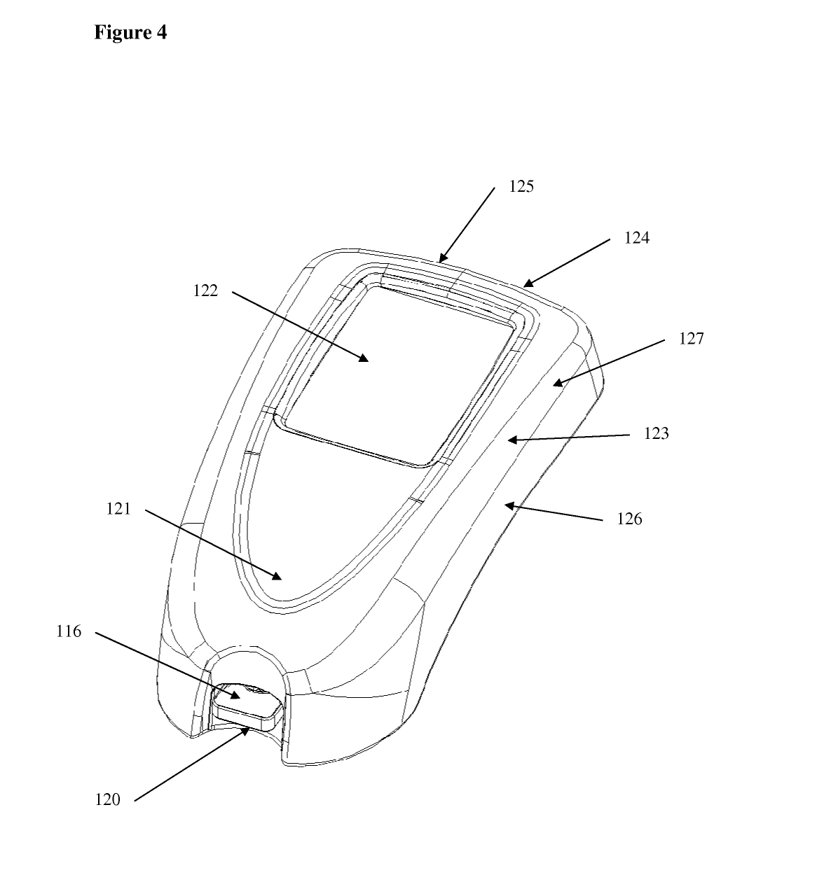

FIG. 4 shows a schematic view of an apparatus for kinetic reading of the signal. The detection cartridge 116 is placed into the holder 120. The apparatus consists of optical unit 121, touch screen 122 and processor unit 123. Other parts of the apparatus include main power switch 124, miniUSB connector 125, which is also used as the charger connector, a chargeable battery 126, and Bluetooth Wlan unit 127. The apparatus is able to read barcodes attached to the cartridge, thus enabling the test identification, as well as input of the master calibration to the software.

### Example 1

### Quantitative CRP Measurement

### Gold-Conjugated Anti-Human CRP Antibody:

The gold particle suspension for preparing the CRP rapid test was made by reducing gold tetrachloride solution by citric acid solution, as previously described, e.g. by A. D. McFarland, C. L. Haynes, C. A. Mirkin, R. P. Van Duyne and H. A. Godwin, “Color My Nanoworld,” J. Chem. Educ. (2004) 81, 544A. Gold particles (40 nm, OD1) were labelled with anti-human CRP antibody by adding 5 mM boric acid and anti-human CRP antibody (0.5 mg per 100 ml of particle suspension) to the gold particle suspension. After mixing for one hour, bovine serum albumin (0.05% as final concentration) was added to the gold particle suspension and the mixing was continued for one hour. The gold particle suspension was concentrated by centrifugation of particles to the bottom of the tube. The liquid was removed and the gold particles were resuspended in 5 mM boric acid. The optical density of the particle suspension was adjusted photometrically to OD10 with 0.5% BSA and 0.05% NaN₃. The labelled CRP antibody particle suspension was mixed with 4% of sucrose. From this solution, 15 μl were dispensed into polypropylene test tubes, and the solution was allowed to dry until the particle suspension had completely dried up to the bottom of the tubes.

### The Rapid Test Strip for the Detection Cartridge:

CRP rapid test strip (detection strip) was prepared onto nitrocellulose membrane by dispensing a test line with CRP monoclonal antibody with a liquid dispenser manufactured by BioDot Ltd. Narrow line of approx. 1 mm in width was dispensed on the nitrocellulose membrane with a liquid dispenser. Immediately after dispensing the membranes were dried at +50° C., so that the lines remained on the membrane as narrow stripes with desired length.

The membrane was attached to the support card (G&L, USA). In addition, a sample membrane and absorbent membrane were placed onto the support such that the other edge of both membranes overlapped about 1 mm with the nitrocellulose membrane in order to allow liquid flow in membrane structure from the test tube through the sample membrane to the nitrocellulose membrane, and finally to the absorbent pad.

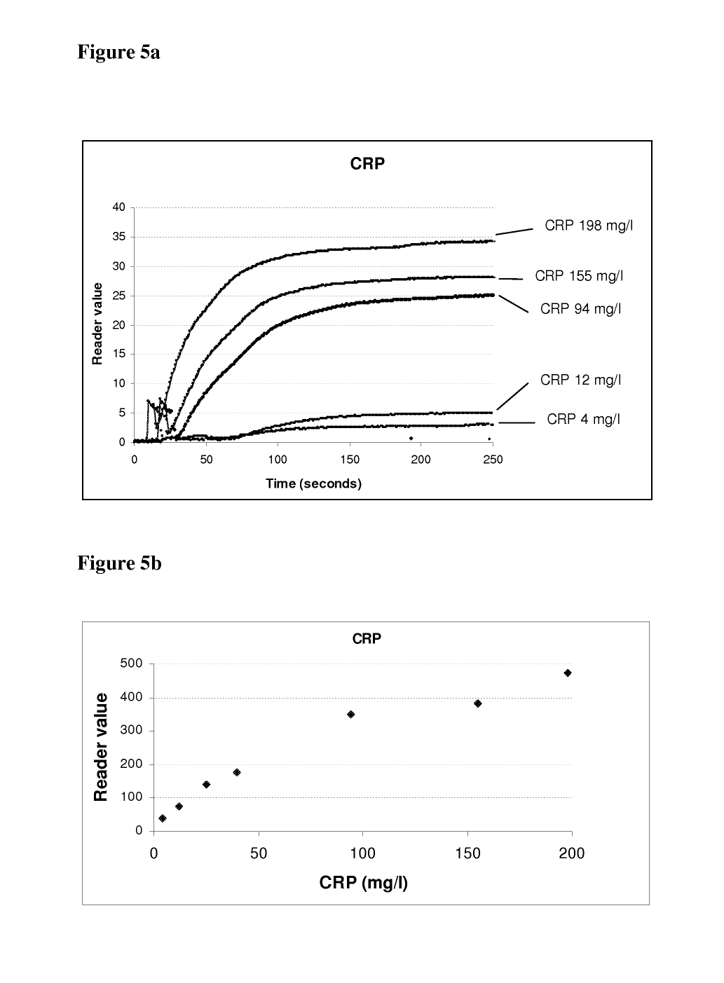

Samples containing different concentrations of CRP (4, 12, 94, 155 and 198 mg/l) were analysed by diluting 10 μl of each sample with phosphate buffered saline (PBS) pH 7.4 containing 0.2% polyvinylpyrrolidine (PVP) and 0.2% bovine serum albumin (BSA). 10 μl of the diluted sample was used to dissolve the dried gold conjugate, and the mixture was transferred into the sample port 118 of the detection cartridge 116. Three drops of the running buffer were added into the buffer well 119. Red lines appeared in the strips at the positions of the test lines, the intensities of which were dependent on the concentrations of CRP in each sample. Development of the signal was monitored by a specific apparatus which enables kinetic measurement. The readings were made continuously (near real-time). The results are presented in FIG. 5a, which shows the reader values monitored until 4 minutes of the various CRP samples (CRP-concentrations 4-198 mg/l, as indicated above).

By comparing the test line reading values formed this way with the standard samples, the correspondence to the concentration of CRP could be concluded accurately by using a dedicated device useful in the invention. FIG. 5b shows the results of the tests in X-Y format. On the basis of numerical values obtained from the device, the concentrations of CRP of unknown samples corresponding to them could be calculated by the reader software.

### Example 2

### Semiquantitative or Qualitative Detection of Streptococcus pyogenes

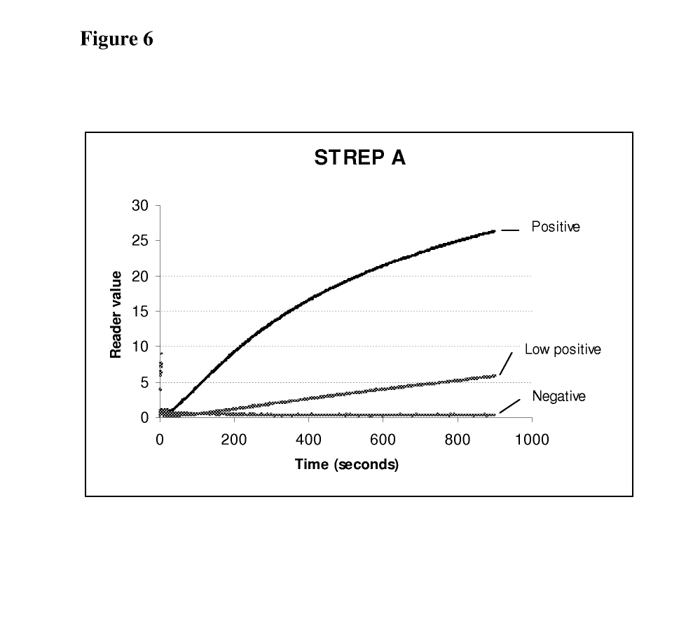

Group A Streptococcus (GAS) antigen was extracted from a sample obtained from a patient suspected of having a streptococcal infection by extraction reagents as described previously (see e.g. R. R. Faclam, Specificity study of kits for detection of group A streptococci directly from throat swabs. J. Clin. Microbiol. vol. 23, 504-508, 1987). 100 μl of the extracted GAS antigen was then allowed to dissolve and react with gold particles sensitised with GAS specific antibody (performed as described in Example 1), followed by transfer of the mixture into the sample port 117 of the detection cartridge 116. The membrane-bound GAS antibodies captured the gold particles causing appearance of a red line. Intensity of this line was converted into numerical value followed by the result classification by a reader device useful in the present invention (FIG. 6).

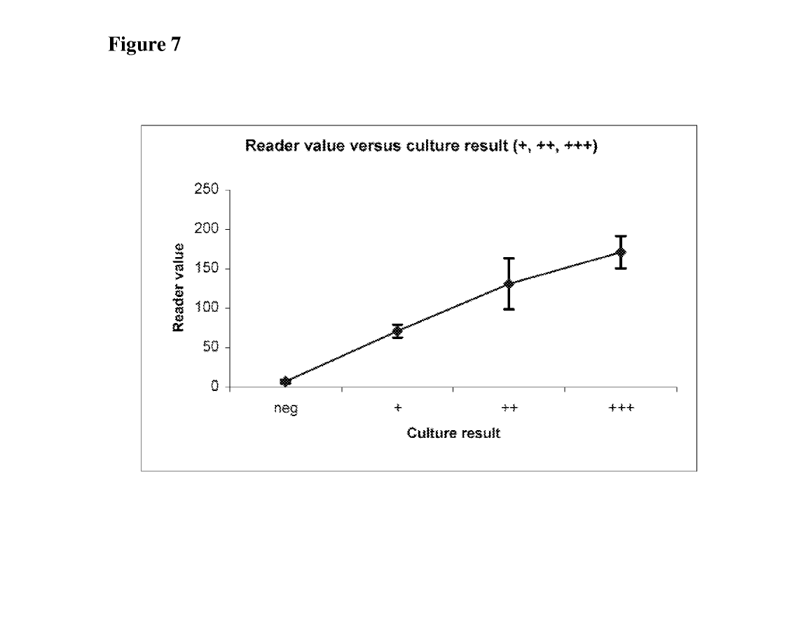

The method of the invention was compared with the traditional culture for GAS. The culture method is either negative (no bacterial growth on the culture plate), or positive (+, ++ or +++) according to the number of bacterial colonies on the plate. The results of comparison are presented in FIG. 7. The throat swab GAS extract results could be concluded accurately by using a dedicated device useful in the present invention, when compared to the traditional culture method.

### Example 3

### Semiquantitative or Qualitative Puumala virus IgM Measurement

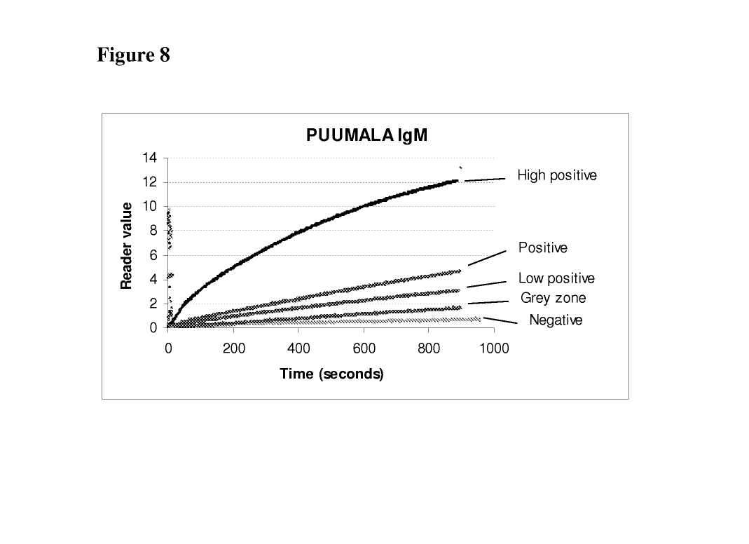

In Puumala hantavirus IgM test 100 μl of the diluted sample (10 μl serum or plasma in 2 ml of dilution buffer similar as in Example 2) was mixed with the gold-conjugated anti-human IgM antibody. In samples containing Puumala virus IgM antibody, it reacted with the gold conjugate forming an antibody-conjugate complex. When 80 μl of the conjugate-sample mixture was transferred into the test cassette's sample port 117 of the detection cartridge 116, the complex was captured by the membrane-bound Puumala virus antigen (recombinant N-protein). The intensity of the red line formed was proportional to the amount of Puumala virus IgM antibody in each sample. The intensity of this line was converted into numerical value followed by the result classification by reader device useful in the present invention as shown in FIG. 8. The final result is achieved by comparing the reader value with the previously set cut-off values. The test is negative when the reader value is below the lower cut-off level and positive when the value is above the higher cut-off level. The reader value in-between the two cut-off levels is regarded as “equivalent” or “grey-zone” result.

1. A method for performing a two-phase rapid test, comprising the steps of
a) placing a predetermined amount of a signal reagent into a container made of non-absorbing material, wherein the container is located separate from the rapid test device,
b) reacting the signal reagent with the analyte(s) present in a test sample by adding a liquid test sample into the container, to obtain a reaction solution,
c) contacting said reaction solution with the rapid test device, wherein a detectable signal is developed by means of the signal reagent,
d) continuously monitoring the development of the signal in the detection zone of the rapid test device by real-time reading of the signal using an apparatus which enables kinetic measurement.

2. The method according to claim 1, wherein said signal reagent is in the container in dry form, being solubilised by means of the test sample.

3. The method according to claim 1, wherein the material of the container is polypropylene, polyethylene or polystyrene.

4. The method according to claim 1, wherein the analyte is selected from the group consisting of nucleic acids, lipids, carbohydrates, vitamins, proteins, polypeptides, bacteria and viruses, and parts or mixtures thereof, and antibodies, antigens, metabolic products and metabolic markers.

5. The method according to claim 1, wherein the signal reagent is made to react with the analyte(s) in the container, from which the signal reagent with the analyte(s) bound to it are transferred into the rapid test device.

6. The method according to claim 1, wherein the signal reagent is prepared from heavy metal, carbon or plastic particles with bioactive molecules bound to them.

7. The method according to claim 6, wherein the heavy metal is gold.

8. The method according to claim 6, wherein the bioactive molecule is a protein, polypeptide, polysaccharide, antigen or hapten.

9. The method according to claim 8, wherein the protein or polypeptide is an antibody.
